(19) United States
(12) Patent Application Publication
(10) Pub. No.: US 2002/0159945 A1
(43) Pub. Date: Oct. 31, 2002

(54) Process for the separation of hydrogen halides by adsorption

(75) Inventors: Rudolf Burghardt, Recklinghausen (DE); John Kahsnitz, Haltern (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DE GUSSA AG, Duesseldorf (DE)

(21) Appl. No.: 10/084,230

(22) Filed: Feb. 28, 2002

(30) Foreign Application Priority Data
Feb. 28, 2001 (DE) 101 09 782.4

(51) Int. Cl. C01B 7/07

(52) U.S. Cl. 423/488

(57) ABSTRACT

Hydrogen halides in the gas phase are separated by a process, comprising contacting a gas comprising at least two hydrogen halides with an adsorbent, whereby the adsorbent selectively adsorbs and retains at least one of the hydrogen halides.

### BACKGROUND OF THE INVENTION

### Field of the Invention

The present invention relates to a process for the separation of hydrogen halides by adsorption, in particular for the removal of small amounts of hydrogen bromide from hydrogen chloride.

Many chemical syntheses are conducted using highly pure hydrogen chloride which is free of hydrogen bromide. An example is the preparation of silicon tetrachloride from hydrogen chloride and silicon. For the synthesis of highly pure silicon tetrachloride for production of optical fibers, the use of hydrogen chloride gas, which is free of hydrogen bromide, is an absolute necessity. The reason for the contamination of hydrogen chloride or hydrochloric acid with hydrogen bromide is frequently the contamination of the brine used for the chloralkali electrolysis with bromides. The bromides are converted electrolytically into elemental bromine. In the subsequent hydrogen chloride synthesis, bromine reacts to form hydrogen bromide.

One method used industrially for removing bromides from the brine is oxidation using chlorine. The bromine formed in this way is removed by stripping with air. In the hot debromination process, steam serves as stripping medium. Other methods of removing bromine from sodium chloride solutions are based on a combination of oxidation by chlorine and reaction of the bromine formed in the aqueous phase or extraction by means of organic solvents.

Japanese publication JP 61 054 235 describes the purification of acid gases or mixtures comprising acid gases (chlorine, hydrogen halides) by adsorption on mordenites. Water is mentioned as a contaminant, while the removal of hydrogen bromide is not explicitly mentioned.

All the processes mentioned can remove bromine to a concentration below 2 ppm by weight only with great difficulty. These processes are therefore unsuitable in practical terms for pretreating brine for the industrial production of bromine-free (<2 ppm by weight) hydrogen chloride. Effective purification processes thus have to be employed for hydrogen chloride gas in order to remove bromine contamination completely.

### SUMMARY OF THE INVENTION

Accordingly, one object of the present invention is to provide an effective means of separating hydrogen halides in a gas phase mixture, particularly small amounts of hydrogen bromide in hydrogen chloride gas.

Briefly, this object and other objects of the invention as hereinafter will become more readily apparent can be attained by a process for the separation of hydrogen halides, comprising: contacting a gas comprising at least two hydrogen halides with an adsorbent, whereby the adsorbent selectively adsorbs and retains at least one of the hydrogen halides.

### BRIEF DESCRIPTION OF THE DRAWING

A more complete appreciation of the invention and many of the attendant advantages thereof will be readily obtained as the same becomes better understood by reference to the following detailed description when considered in connection with the accompanying drawings, wherein

the FIGURE is a graph of HBr content in a gas mixture of HCl and HBr in the gas feed and gas outflow from an adsorber which contains an adsorbent.

### DETAILED DESCRIPTION OF THE PREFERRED EMBODIMENTS

It has been found that hydrogen halides can be separated by adsorption. In particular, it has been found that bromine present in hydrogen chloride as hydrogen bromide can be removed from hydrogen chloride by adsorption.

In the present process for the separation of hydrogen halides, a gas comprising at least two hydrogen halides is brought into contact with an adsorbent and the adsorbent selectively retains at least one hydrogen halide.

The adsorption process produces very sharp separation, because the adsorbent has a very large number of theoretical separation stages, so that, for example, a reduction in the bromine content in a hydrogen halide gas mixture to concentrations of less than 2 ppm by weight is possible. This is surprising in view of the fact that, in the case of the removal of a small amount of hydrogen bromide from hydrogen chloride, the hydrogen chloride is present in a very large excess as competitor in the adsorption of gases in the adsorption process.

The concentration of the hydrogen halides to be purified, in particular hydrogen chloride gas, in the gas is 10-100% by volume, preferably 50-100% by volume, particularly preferably 90-100% by volume. The remainder of the gas is generally air or nitrogen or another appropriate inert gas.

The concentration of the hydrogen halide to be removed, in particular the hydrogen bromide, in the gas is, depending on the origin of the salt used for the electrolysis, 0.1-20,000 ppm by weight, preferably from 0.5 to 2,000 ppm by weight, particularly preferably from 1 to 500 ppm by weight.

Apart from zeolites as a suitable adsorbent, activated carbon of a variety of types is particularly useful as adsorbent for the separation. The adsorbent can be used in powder form or preferably in pelletized form.

The adsorbent can be employed, in particular, in a fixed bed, a moving bed or a fluidized bed. When a fixed bed is employed, it is possible, as is customary in adsorption processes, for a plurality of fixed beds to be arranged in series or in parallel or else in combinations, so that it is easier to recognize saturation and prevent breakthrough and also to carry out regeneration.

The temperature during the adsorption process ranges from 0-100° C., preferably 0-50° C., particularly preferably 0-30° C. To set the optimum temperature, generally very low, temperature, cooling may have to be employed, although in the case of very low exterior temperatures heating may be necessary.

The pressure in the adsorption step ranges from 0.1 to 20 bar, preferably 0.2-10 bar, particularly preferably 1-3 bar, very particularly preferably about 1 bar (ambient pressure). In the case of a fixed-bed arrangement, the empty tube velocity is particularly preferably 0.1-40 cm/s.

The laden adsorbent can, for example, be regenerated thermally and recycled.

Having generally described this invention, a further understanding can be obtained by reference to certain specific examples which are provided herein for purposes of illustration only and are not intended to be limiting unless otherwise specified.

### EXAMPLE

The experimental parameters and results of an adsorption experiment for the separation of hydrogen bromide and hydrogen chloride are shown in Table 1 below.

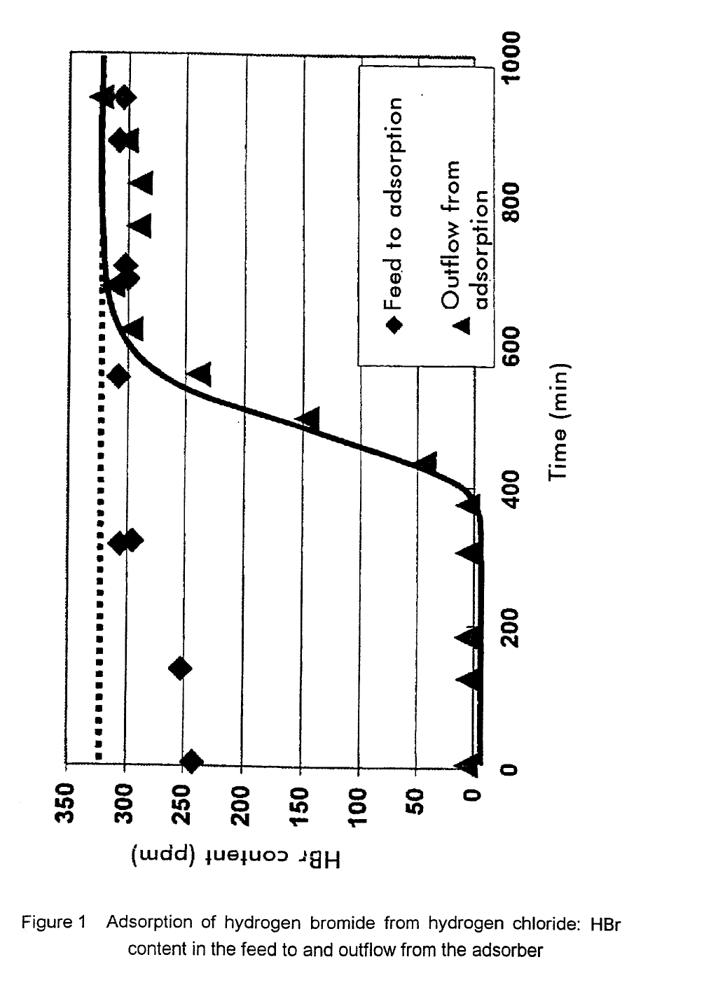

FIG. 1 shows the results of the adsorption experiment. The figure shows the hydrogen bromide concentration in the inflow to and outflow from the adsorber as a function of time. The adsorbent used was an activated carbon (weight used: 93.3 g) from Carbo-Tech (CMS-H). The volume flow of hydrogen chloride was about 150 liter/h. Before breakthrough of the hydrogen bromide, the hydrogen bromide concentration is less than 2 ppm by weight, which is the analytical detection limit under these conditions. The experiment shows that virtually complete removal of the hydrogen bromide is achieved over a relatively long time.

TABLE 1
Experimental parameters and results of an adsorption experiment
on the separation of hydrogen bromide and hydrogen chloride
Adsorber column

| Bed height | 400 | mm |
|---|---|---|
| Diameter | 20 | mm |
| Bed volume | 0.13 | liter |
| Adsorbent | Activated carbon CMS-H | |
| Supplier | Carbo-Tech | |
| Weight used | 93.92 | G |

Operating conditions

| | | |
|---|---|---|
| Feed | 146 | liter/h |
| HBr content | 300 | ppm (m/m |
| Empty tube velocity | 0.13 | m/s |
| Residence time in the bed | 3.1 | S |

Adsorber performance

| | | |
|---|---|---|
| Equilibrium loading | 0.7% | of HBr |
| Equilibrium loading | 6% | HCl |
| Time to breakthrough | 8.3 | h |
| Outflow concentration | <2 | ppm (m/m) |

The disclosure of German priority application 10109782.4 filed Feb. 28, 2001 is hereby incorporated by reference into the present application.

Obviously, numerous modifications and variations of the present invention are possible in light of the above teachings. It is therefore to be understood that within the scope of the appended claims, the invention may be practiced otherwise than as specifically described herein.

What is claimed as new and is intended to be secured by Letters Patent is:

1. A process for the separation of hydrogen halides, comprising:
contacting a gas comprising at least two hydrogen halides with an adsorbent, whereby the adsorbent selectively adsorbs and retains at least one of the hydrogen halides.

2. The process as claimed in claim 1, wherein one of the hydrogen halides is hydrogen chloride and the other hydrogen halide is hydrogen bromide.

3. The process as claimed in claim 1, wherein the concentration of the hydrogen halides to be purified in the gas is 10-100% by volume.

4. The process as claimed in claim 3, wherein the concentration of the hydrogen halides in the gas ranges from 50-100% by volume.

5. The process as claimed in claim 4, wherein the concentration of the hydrogen halides in the gas ranges from 90-100% by volume.

6. The process as claimed in claim 1, wherein the bromine concentration of the gas is reduced to less than 2 ppm.

7. The process as claimed in claim 1, wherein hydrogen bromide is removed from hydrogen chloride.

8. The process as claimed in claim 7, wherein the concentration of hydrogen bromide in the gas is 0.1-20,000 ppm by weight.

9. The process as claimed in claim 8, wherein said concentration of hydrogen bromide is 0.5-2,000 ppm by weight.

10. The process as claimed in claim 9, wherein said concentration of hydrogen bromide is 1-500 ppm by weight.

11. The process as claimed in claim 1, wherein the said adsorption is conducted at a temperature of 0-100° C.

12. The process as claimed in claim 11, wherein the said adsorption is conducted at a temperature of 0-50° C.

13. The process as claimed in claim 12, wherein the said adsorption is conducted at a temperature of 0-30° C.

14. The process as claimed in claim 1, wherein said adsorbent is activated carbon or a zeolite.

15. The process as claimed in claim 1, wherein said adsorbent is in the form of a fixed bed, a moving bed or a fluidized bed.

16. The process as claimed in claim 1, wherein the pressure in the adsorption process ranges from 0.1 to 20 bar.

17. The process as claimed in claim 16, wherein said pressure ranges from 0.2 to 10 bar.

18. The process as claimed in claim 17, wherein said pressure ranges from 1 to 3 bar.

19. The process as claimed in claim 17, wherein said pressure is ambient pressure.

20. The process as claimed in claim 1, wherein the adsorption process is conducted in a fixed bed adsorber at an empty tube velocity ranging from 0.1-40 cm/s.
